(19) United States
(12) Patent Application Publication
(10) Pub. No.: US 2025/0183587 A1
(43) Pub. Date: Jun. 5, 2025

(54) CONNECTOR

(71) Applicant: SUMITOMO WIRING SYSTEMS, LTD., Mie (JP)

(72) Inventor: Keisuke TERAMOTO, Mie (JP)

(21) Appl. No.: 18/845,896

(22) PCT Filed: Mar. 2, 2023
(86) PCT No.: PCT/JP2023/007713

§ 371 Date: Sep. 11, 2024

(30) Foreign Application Priority Data
Mar. 22, 2022 (JP) 2022-045377

(51) Int. Cl. H01R 13/627

(52) U.S. Cl. CPC H01R 13/6272

(57) ABSTRACT

A housing (20) includes a locking arm (26) to which a counterpart connector (70) is locked. The locking arm (26) extends in a front-rear direction above one surface of the housing (20), is elastically deformable in a direction in which the locking arm (26) approaches the one surface of the housing (20), and includes a press-to-unlock portion (31) capable of being pressed toward the one surface of the housing (20). The housing (20) includes a wall portion (38) that protrudes from the one surface and faces the press-to-unlock portion (31) from a rear side.

### TECHNICAL FIELD

The present disclosure relates to a connector.

### BACKGROUND

The connector disclosed in Patent Document 1 includes a housing to which a counterpart connector can be fitted from the front side. The housing includes a locking arm that protrudes from one surface of the housing and extends in a front-back direction. The locking arm is elastically deformable in a vertical direction. A state in which the housing and the counterpart connector are fitted to each other is maintained due to the counterpart connector being locked to the locking arm. The locking arm includes a press-to-unlock portion (referred to as a “locking operation portion” in Patent Document 1) to be pressed for unlocking, at its rear end portion. Patent Document 2 also discloses a connector with such a locking arm.

### PRIOR ART DOCUMENT

### Patent Document

Patent Document 1: JP 2021-190298 A

Patent Document 2: JP 2017-162667 A

### SUMMARY OF THE INVENTION

### Problems to Be Solved

Incidentally, due to a reduction in size of a connector, a finger of an operator may accidentally touch the press-to-unlock portion during an operation for fitting the counterpart connector to the housing. If the fitting operation is continued while the finger is pressing the press-to-unlock portion, the locking arm will not elastically return at the time of proper fitting, and no locking sound, which is a sound generated by the locking arm hitting the wall surface or the like of the housing, can be heard. Also, the operator cannot feel a suitable locking sensation. As a result, there is a concern that the operator may prematurely finish the fitting operation without noticing that the housing and the counterpart connector are in a semi-fitted state where they are not properly fitted to each other.

Therefore, it is an object of the present disclosure to provide a connector capable of preventing a counterpart connector from being connected to the connector in a semi-fitted state.

### Means to Solve the Problem

A connector of the present disclosure includes a housing to which a counterpart connector can be fitted from a front side, wherein the housing includes a locking arm to which the counterpart connector is locked, the locking arm extends in a front-rear direction above one surface of the housing, is elastically deformable in a direction in which the locking arm approaches the one surface of the housing, and includes a press-to-unlock portion capable of being pressed toward the one surface of the housing, and the housing includes a wall portion that protrudes from the one surface and faces the press-to-unlock portion from a rear side.

### Effect of the Invention

With the present disclosure, it is possible to provide a connector capable of preventing a counterpart connector from being connected to the connector in a semi-fitted state.

### BRIEF DESCRIPTION OF THE DRAWINGS

FIG. 1 is a perspective view of a housing of a connector according to Embodiment 1 of the present disclosure.

FIG. 2 is a plan view of the housing.

FIG. 3 is a front view of the housing.

FIG. 4 is a plan view showing a state in which the housing and a counterpart connector are properly fitted to each other.

FIG. 5 is a back view showing the state in which the housing and the counterpart connector are properly fitted to each other, in which terminal fittings and electric wires are omitted.

FIG. 6 is a cross-sectional view showing the state in which the housing and the counterpart connector are properly fitted to each other.

### DETAILED DESCRIPTION TO EXECUTE THE INVENTION

### Description of Embodiments of the Present Disclosure

First, aspects of the present disclosure will be listed and described.

(1) A connector of the present disclosure includes a housing to which a counterpart connector can be fitted from a front side, wherein the housing includes a locking arm to which the counterpart connector is locked, the locking arm extends in a front-rear direction above one surface of the housing, is elastically deformable in a direction in which the locking arm approaches the one surface of the housing, and includes a press-to-unlock portion capable of being pressed toward the one surface of the housing, and the housing includes a wall portion that protrudes from the one surface and faces the press-to-unlock portion from a rear side.

With this configuration, an operator can fit the counterpart connector to the housing by pressing the wall portion from the rear side. Accordingly, it is possible to avoid contact of a finger of the operator with the press-to-unlock portion.

In the state in which the housing and the counterpart connector are properly fitted to each other, the locking arm can elastically return appropriately and generate the locking sound. At this time, the operator can hear the locking sound as well as feel a suitable locking sensation, and can thus determine that the housing and the counterpart connector have been properly fitted to each other. As a result, it is possible to prevent the housing and the counterpart connector from being left in a semi-fitted state.

(2) It is preferable that a protrusion size of the wall portion from the one surface is larger than a distance from the one surface to a pressing surface of the press-to-unlock portion.

With this configuration, a tall wall portion is located behind the press-to-unlock portion, and thus it is possible to more reliably avoid contact of the finger of the operator with the press-to-unlock portion.

(3) It is preferable that a width in a left-right direction of the wall portion is larger than a width in the left-right direction of the press-to-unlock portion.

With this configuration, a wide wall portion is located behind the press-to-unlock portion, and thus it is possible to more reliably avoid the contact of the finger of the operator with the press-to-unlock portion.

(4) It is preferable that the housing includes a finger placement face on the one surface on a rear side with respect to the wall portion.

With this configuration, the operator can press the wall portion while placing the finger on the finger placement face, and therefore, it is possible to easily conduct the fitting operation and to more reliably avoid the contact of the finger of the operator with the press-to-unlock portion.

(5) It is preferable that the housing includes a pair of side wall portions that protrude from left and right sides of the locking arm on the one surface with the locking arm being located between the side wall portions, and at least one of the pair of side wall portions is coupled to the wall portion.

With this configuration, the wall portion is reinforced with the side wall portion, and thus it is possible to ensure rigidity to an extent that the wall portion can withstand the pressing. In particular, since the side wall portion protects the locking arm from the lateral side, the structure of the connector does not become complicated unlike a case where a dedicated reinforcing means for reinforcing the wall portion is provided.

(6) It is preferable that one end portion of left and right end portions of the wall portion is coupled to the one of the side wall portions, and the other end portion is separate from the other of the side wall portions and forms an unlocking space with the other side wall portion.

To detach the housing and the counterpart connector from each other, it is necessary to unlock the locking arm by pressing the press-to-unlock portion. However, with the present disclosure, the wall portion faces the press-to-unlock portion from the rear side and thus the wall portion hinders and makes it difficult to press the press-to-unlock portion. In view of this, with this configuration, the operator can put the finger into the unlocking space formed between the wall portion and the side wall portions and press the press-to-unlock portion, thus making it possible to appropriately unlock the locking arm.

### Details of Embodiments of the Present Disclosure

The following describes specific examples of the present disclosure with reference to the drawings. The present invention is not limited to these examples, but rather is indicated by the scope of the claims and is intended to include all modifications within the scope and meaning equivalent to the scope of the claims.

### Embodiment 1

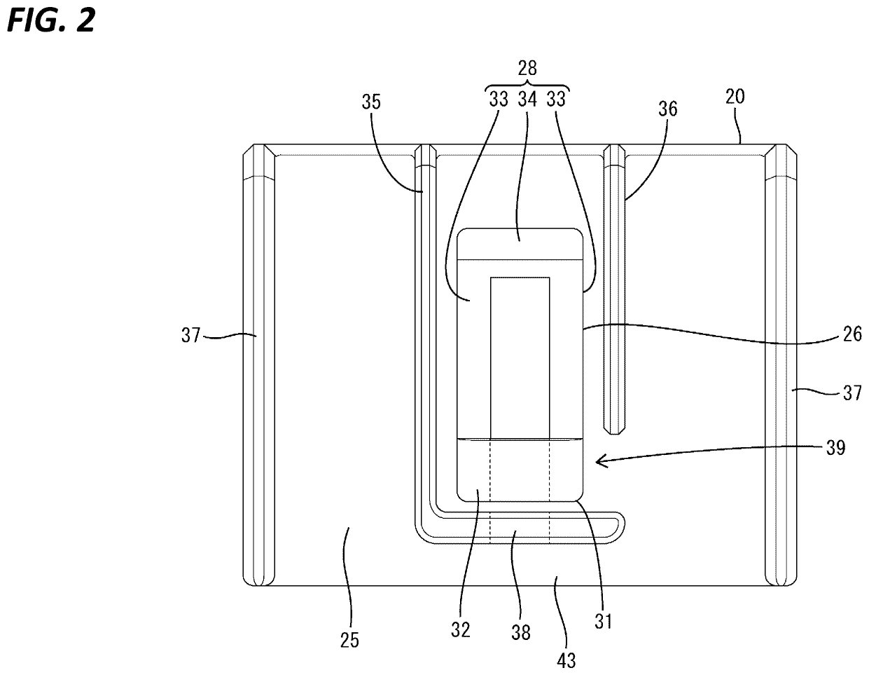

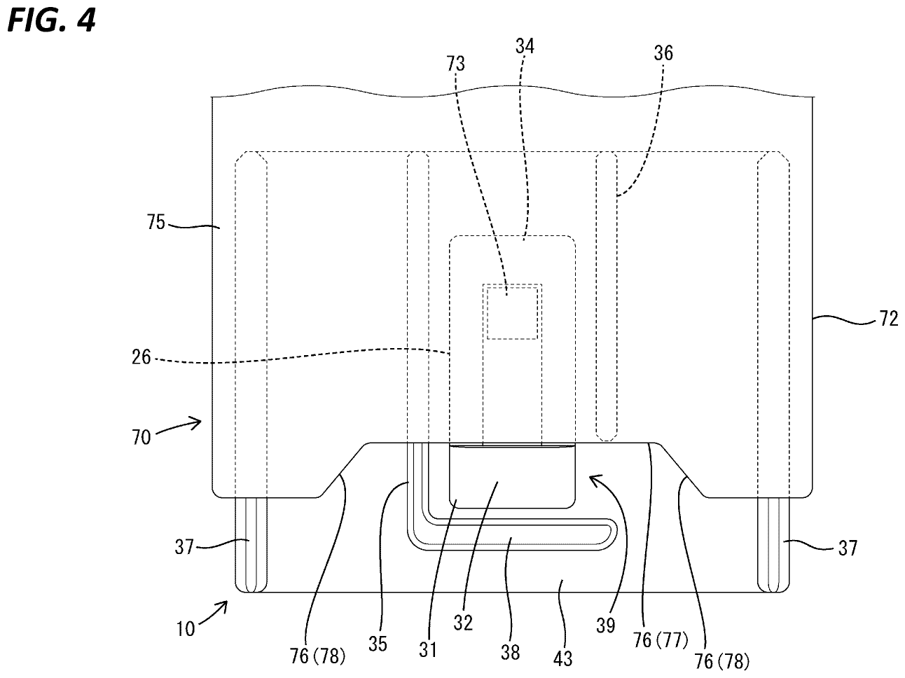

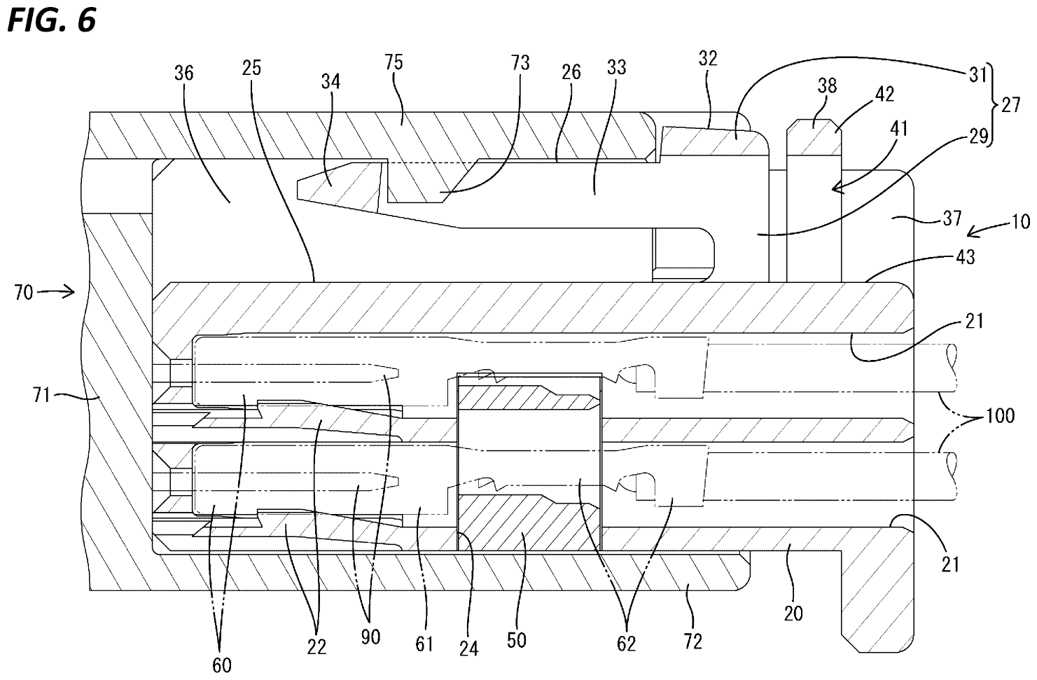

As shown in FIG. 6, a connector 10 according to Embodiment 1 of the present disclosure includes a housing 20 and terminal fittings 60. The housing 20 can be fitted to a counterpart connector 70. Note that, in the following description, a side on which faces of the housing 20 and the counterpart connector 70 are opposed to each other at the start of the fitting operation is taken as the front side in a front-rear direction. The vertical direction (height direction) is based on the vertical directions in the diagrams other than FIGS. 2 and 4. The left-right direction (width direction) is based on the left-right directions in the diagrams other than FIG. 6. These directions do not necessarily correspond to the directions of the connector 10 mounted in a vehicle or the like (not illustrated).

### Counterpart Connector

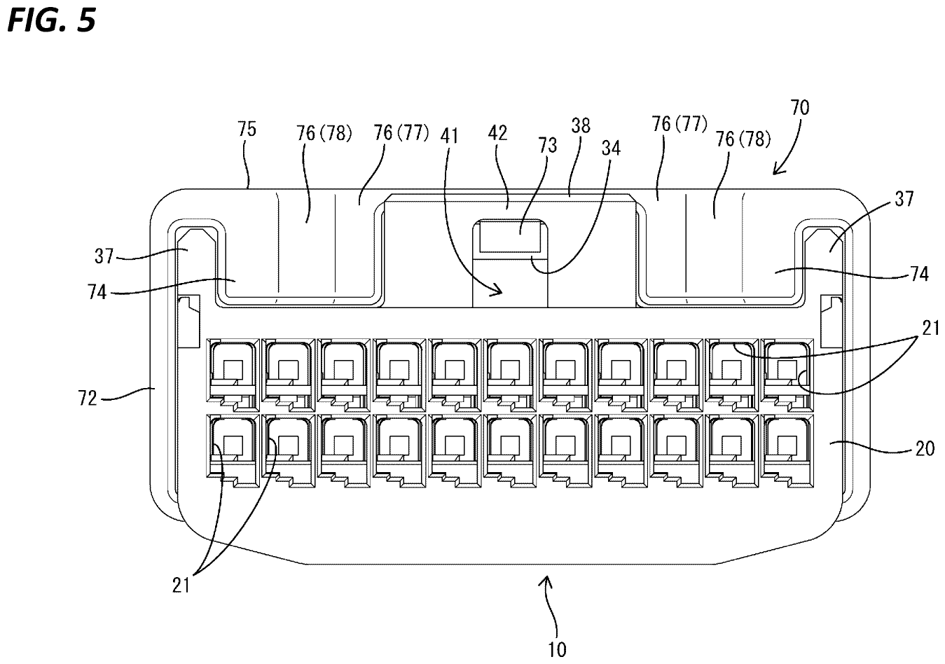

As shown in FIG. 6, the counterpart connector 70 includes a counterpart housing 71 and counterpart terminal fittings 90. The counterpart housing 71 is made of a synthetic resin, and includes a hood portion 72 that has a polygonal-tube shape and is open forward. A locking portion 73 having a hook-like shape protrudes from the inner surface of an upper wall 75 of the hood portion 72. As shown in FIG. 4, the locking portion 73 is located in a portion that corresponds to an intermediate portion with respect to the left-right direction as well as an intermediate portion with respect to the front-rear direction on the inner surface of the upper wall 75. As shown in FIG. 5, on the inner surface of the upper wall 75, a pair of guide portions 74 is formed on the left and right sides of the locking portion 73 with the locking portion 73 being located therebetween. The guide portions 74 have a rib-like shape and extend in the front-rear direction.

As shown in FIG. 4, a recessed portion 76 with a concave shape is formed in an intermediate portion with respect to the left-right direction at the front end of the upper wall 75. The recessed portion 76 includes an interior edge portion 77 that extends over a broad range in the left-right direction, and inclined edge portions 78 that form a tapered shape such that the distance therebetween decreases from the left and right side portions at the front end of the upper wall 75 toward the interior edge portion 77. As shown in FIG. 5, the inclined edge portions 78 and the left and right end portions of the interior edge portion 77 are formed on the guide portions 74 and have a height corresponding to the thickness of the guide portions 74 in the vertical direction.

As shown in FIG. 6, a plurality of counterpart terminal fittings 90 protrude inside the hood portion 72. The counterpart terminal fittings 90 are each configured as a male terminal made of a conductive metal. The counterpart terminal fittings 90 have a pin shape or tab shape and extend in the front-rear direction inside the hood portion 72.

### Housing and Terminal Fitting

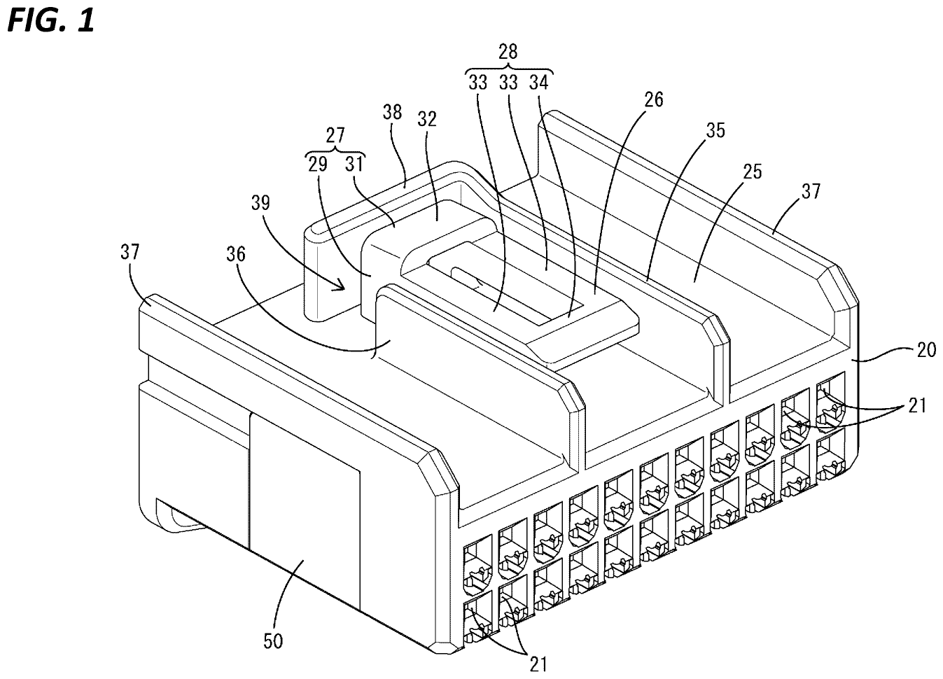

The housing 20 is made of a synthetic resin and has a flat shape that is elongated in the left-right direction as shown in FIG. 1. As shown in FIG. 6, the housing 20 includes a plurality of cavities 21 extending in the front-rear direction. In the housing 20, the cavities 21 are arranged to form two rows in the vertical direction and are lined up in the width direction in each row. A lance 22 protrudes from the inner wall of each cavity 21. The terminal fittings 60 are inserted into the cavities 21 from the rear side. The terminal fittings 60 are locked to the lances 22, and thus their dislodgement from the cavities 21 is prevented.

The terminal fittings 60 are each configured as a female terminal made of a conductive metal. As shown in FIG. 6, the terminal fitting 60 includes a tubular main body portion 61, and a barrel portion 62 formed behind the main body portion 61. The barrel portion 62 is crimped to the terminus of an electric wire 100. The main body portion 61 is connected to the counterpart terminal fitting 90 that is inserted thereinto when the housing 20 and the counterpart connector 70 are properly fitted to each other. The electric wire 100 is drawn out to the rear from the housing 20.

A retainer attachment hole 24 is open in the lower surface of the housing 20. The retainer attachment hole 24 is in communication with the cavities 21 inside the housing 20, and is also open in the left and right side surfaces of the housing 20. A retainer 50 is inserted into the retainer attachment hole 24 from below. The terminal fittings 60 are secondarily locked by the retainer 50.

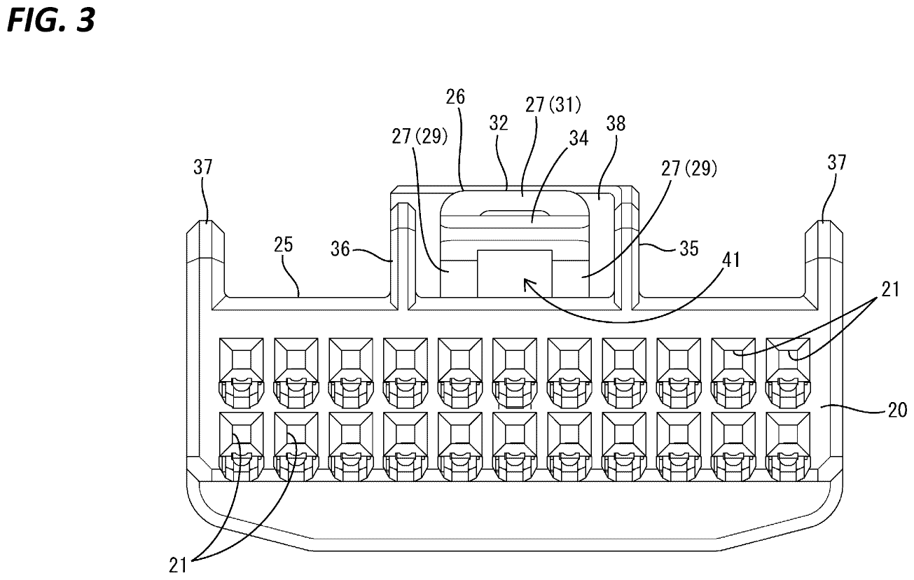

As shown in FIG. 1, an upper surface 25 (one surface) of the housing 20 is flat. A locking arm 26 protrudes from the upper surface 25 of the housing 20. The locking arm 26 is located in a portion that corresponds to an intermediate portion with respect to the left-right direction as well as an intermediate portion with respect to the front-rear direction on the upper surface 25 of the housing 20. The locking arm 26 includes a support portion 27 that rises from the upper surface 25, and an extension portion 28 that extends forward from the support portion 27. As shown in FIG. 3, the support portion 27 has a gate-like frame shape, and includes a pair of leg portions 29 that rise spaced apart from each other in the left-right direction, and a press-to-unlock portion 31 that extends in the left-right direction and couples the upper ends of the leg portions 29.

The locking arm 26 can be elastically deformed from a natural state so as to come close to the upper surface 25 of the housing 20 during a process of fitting the housing 20 and the counterpart connector 70 to each other. The leg portions 29 serve as fulcrum portions when the locking arm 26 is elastically deformed. As shown in FIG. 6, the size in the front-rear direction of the press-to-unlock portion 31 is larger than the sizes in the front-rear direction of the leg portions 29. The front end of the press-to-unlock portion 31 is located on the front side with respect to the front ends of the leg portions 29. The upper surface of the press-to-unlock portion 31 is configured as a pressing surface 32 that is located at the highest position in the locking arm 26. The pressing surface 32 is flat in the left-right direction, and is inclined upward as it extends forward.

As shown in FIG. 1, the extension portion 28 includes a pair of arm portions 33 that extend from the leg portions 29 as a pair, and a locking main body portion 34 that bridges the front ends of the arm portions 33. The root portion at the rear end of each arm portion 33 is coupled to the press-to-unlock portion 31 such that a step is formed. When the pressing surface 32 of the press-to-unlock portion 31 is pressed, the arm portions 33 are inclined such that their front ends move downward, and the locking arm 26 is elastically deformed. As shown in FIG. 3, the locking main body portion 34 is located below the press-to-unlock portion 31.

As shown in FIG. 1, on the upper surface 25 of the housing 20, a pair of side wall portions 35 and 36 are formed on the left and right sides of the locking arm 26 with the locking arm 26 being located therebetween. The side wall portions 35 and 36 are board-shaped walls that rise from the upper surface 25 of the housing 20 and extend in the front-rear direction, and their surfaces face in the left-right direction. The side wall portions 35 and 36 extend rearward from the front end of the upper surface 25 of the housing 20 over a broad range and cover the locking arm 26 from the left and right sides.

Regarding the side wall portions 35 and 36, a first side wall portion 35 is larger than a second side wall portion 36 in the front-rear direction. The rear end of the first side wall portion 35 is located on the rear side with respect to the rear end of the locking arm 26 and specifically the press-to-unlock portion 31. The rear end of the second side wall portion 36 is located on the front side with respect to the rear end of the locking arm 26 and specifically the press-to-unlock portion 31.

End wall portions 37 that are board-shaped walls having a shape similar to that of the side wall portions 35 and 36 are formed at the left and right end portions of the upper surface 25 of the housing 20. The end wall portions 37 extend over the entire length in the front-rear direction of the upper surface 25 of the housing 20 and are in parallel with the side wall portions 35 and 36. When the housing 20 and the counterpart connector 70 are fitted to each other, the guide portions 74 of the counterpart housing 71 are respectively fitted between the end wall portion 37 and the side wall portion 35 and between the end wall portion 37 and the side wall portion 36 (see FIG. 5, though the side wall portions 35 and 36 are not illustrated).

As shown in FIG. 1, on the upper surface 25 of the housing 20, a wall portion 38 that faces the rear end portion (including the press-to-unlock portion 31 and the like) of the locking arm 26 from the rear side. The wall portion 38 is located on the upper surface 25 of the housing 20 at a position that is on the rear side with respect to the locking arm 26 and on the front side with respect to the rear end of the housing 20. The wall portion 38 is a board-shaped wall that rises from the upper surface 25 of the housing 20, and extends in the left-right direction with its surfaces facing in the front-rear direction. One end portion (corresponding to the right end portion in FIG. 1 and the left end portion in FIGS. 2 and 4) of the left and right end portions of the wall portion 38 is coupled to the rear end of the first side wall portion 35. The other end portion (corresponding to the left end portion in FIG. 1 and the right end portion in FIGS. 2 and 4) of the left and right end portions of the wall portion 38 is located on the rear side with respect to the second side wall portion 36 and forms an unlocking space 39 together with the second side wall portion 36. The width in the front-rear direction of the opening of the unlocking space 39 is larger than the size in the front-rear direction of the press-to-unlock portion 31 and is set to such a size that allows the entry of a finger of an operator.

In Embodiment 1, as shown in FIG. 2, the thickness in the front-rear direction of the wall portion 38 is larger than the thicknesses in the front-rear direction of the side wall portions 35 and 36. The size in the left-right direction of the wall portion 38 is larger than the size in the left-right direction of the press-to-unlock portion 31. The wall portion 38 is large enough to cover the entire press-to-unlock portion 31 from the rear side. When the housing 20 is viewed from the rear side, the press-to-unlock portion 31 is hidden by the wall portion 38 and cannot be seen (see FIG. 5).

The upper end of the wall portion 38 is continuous in the left-right direction and is located above the pressing surface 32 of the press-to-unlock portion 31 as shown in FIG. 6. In other words, the height of the wall portion 38 is larger than the distance from the upper surface 25 of the housing 20 to the front end of the pressing surface 32. As shown in FIG. 1, the side wall portion 35 includes, at its upper end, a portion that is inclined on the lateral side of the press-to-unlock portion 31 upward toward the upper end of the wall portion 38.

As shown in FIG. 5, a through hole 41 is formed in an intermediate portion with respect to the left-right direction of the wall portion 38. The through hole 41 results from the drawing of a die for molding the locking main body portion 34 and penetrates, in the front-rear direction, the intermediate portion with respect to the left-right direction of the wall portion 38. When the housing 20 is viewed from the rear side, the locking main body portion 34 can be seen through the through hole 41. In the wall portion 38, the thickness in the vertical direction of a beam portion 42 that extends in the left-right direction and defines the upper end of the through hole 41 is larger than the thickness in the vertical direction of the press-to-unlock portion 31 as shown in FIG. 6.

As shown in FIG. 2, a finger placement face 43 is formed between the rear end and the wall portion 38 on the upper surface 25 of the housing 20. The finger placement face 43 is a flat face that is continuous with a peripheral portion of the upper surface 25 of the housing 20 with no steps formed, and is not processed into a special shape. The finger placement face 43 has an area (with sizes in the front-rear direction and the left-right direction) that allows an operator to place a finger on the rear side of the wall portion 38.

### Effects of Connector

To fit the housing 20 and the counterpart connector 70 to each other, the housing 20 is lightly inserted into the hood portion 72. Next, a portion of a finger of an operator (e.g., a side surface of the thumb) is placed on the finger placement face 43, and another portion of the finger (e.g., the inner surface of the thumb) is pressed against the rear surface of the wall portion 38. In this state, the wall portion 38 is pressed forward. Then, the housing 20 is inserted deeply into the hood portion 72.

During the process of fitting the housing 20 and the counterpart connector 70 to each other, the locking main body portion 34 interferes with the locking portion 73, and the locking arm 26 is elastically deformed downward. During this process, the finger of the operator continues to press the wall portion 38, thus making it possible to prevent the press-to-unlock portion 31 from being pressed by the finger and being elastically deformed accidentally. In addition, the guide portions 74 enter between the end wall portion 37 and the side wall portion 35 and between the end wall portion 37 and the side wall portion 36 while being fitted thereinto, and the fitting of the housing 20 and the counterpart connector 70 is thus guided.

When the housing 20 and the counterpart connector 70 are properly fitted to each other, the locking arm 26 elastically returns, and the locking main body portion 34 is located so as to be capable of being locked to the locking portion 73. Accordingly, the state in which the housing 20 and the counterpart connector 70 are fitted to each other is maintained. With the proper fitting of the housing 20 and the counterpart connector 70, the locking main body portion 34 hits the inner surface of the upper wall 75 of the hood portion 72 while being biased by the elastic reaction force from the locking arm 26, and thus a locking sound (sound if impact) such as a “click” or a “snap” is given off. The operator can confirm that the housing 20 and the counterpart connector 70 have been properly fitted to each other by hearing this locking sound as well as feeling a suitable locking sensation with their tactile sense.

As shown in FIG. 4, the press-to-unlock portion 31 is placed inside the recessed portion 76 of the hood portion 72 in the state in which the housing 20 and the counterpart connector 70 are properly fitted to each other. At this time, the front end of the press-to-unlock portion 31 is placed along the interior edge portion 77 of the recessed portion 76. In addition, the press-to-unlock portion 31 faces the inclined edge portions 78 via the unlocking space 39.

When the housing 20 and the counterpart connector 70 that have been fitted to each other are detached for maintenance or the like, a finger of the operator presses the pressing surface 32 of the press-to-unlock portion 31 from above. In Embodiment 1, the finger can be inserted into unlocking space 39, thus making it possible to elastically deform the pressing surface 32 of the press-to-unlock portion 31 without effect. When the press-to-unlock portion 31 is pressed, the locking arm 26 is elastically deformed downward, and the state in which the locking main body portion 34 and the locking portion 73 are locked to each other is released. In this state, the housing 20 can be removed from the counterpart connector 70, thus making it possible to detach the housing 20 and the counterpart connector 70 from each other.

As described above, with Embodiment 1, the operator can fit the housing 20 and the counterpart connector 70 to each other by pressing the wall portion 38 from the rear side, and therefore, the finger of the operator is unlikely to touch the press-to-unlock portion 31, thus making it possible to avoid a situation in which the press-to-unlock portion 31 is pressed during the fitting process and thus the locking arm 26 is elastically deformed accidentally. As a result, when the housing 20 and the counterpart connector 70 are properly fitted to each other, the locking arm 26 can generate the locking sound in a free state, and it is possible to prevent the housing 20 and the counterpart connector 70 from being left in a semi-fitted state.

In particular, the protrusion size from the upper surface 25 of the housing 20 to the upper end of the wall portion 38 is larger than the distance from the upper surface 25 of the housing 20 to the pressing surface 32 of the press-to-unlock portion 31, and the size in the left-right direction of the wall portion 38 is larger than the size in the left-right direction of the press-to-unlock portion 31, thus making it possible to more reliably avoid contact of the finger of the operator with the press-to-unlock portion 31.

Also, the finger placement face 43 is formed on the upper surface 25 of the housing 20 on the rear side with respect to the wall portion 38, and a finger can be placed on the finger placement face 43, thus making it possible to easily conduct the fitting operation and to more reliably avoid the contact of the finger with the press-to-unlock portion 31.

Furthermore, the rear end of the first side wall portion 35 is coupled to the wall portion 38 and the wall portion 38 is reinforced with the side wall portion 35, thus making it possible to impart rigidity to an extent that the wall portion 38 can withstand the pressing. In addition, since the side wall portion 35 protects the locking arm 26 from the lateral side, the structure of the connector 10 does not become complicated unlike a case where a dedicated reinforcing means for reinforcing the wall portion 38 is provided.

Moreover, since the rear end of the second side wall portion 36 is separate from the wall portion 38 and the unlocking space 39 is formed between the side wall portion 36 and the wall portion 38, and therefore, the housing 20 and the counterpart connector 70 can be detached from each other by the operator inserting a finger into the unlocking space 39 and pressing the press-to-unlock portion 31. As a result, the locking of the locking main body portion 34 and the locking portion 73 can be properly released.

### Other Embodiments of the Present Disclosure

Embodiment 1 above disclosed herein is exemplary in all respects, and should be construed as being not limitative.

In Embodiment 1 above, the first side wall portion is coupled to the wall portion. However, in another embodiment, a configuration may be employed in which both of the side wall portions are separate from the wall portion and form an unlocking space with the wall portion. Alternatively, both of the side wall portions may be coupled to the wall portion.

In Embodiment 1 above, the locking arm is coupled to the upper surface of the housing via the support portion. However, in another embodiment, the locking arm need not be coupled to the upper surface of the housing and may be coupled to the side wall portions via support portions protruding toward the left and right sides.

In Embodiment 1 above, the extension portion of the locking arm extends forward from the support portion. However, in another embodiment, the extension portion of the locking arm may extend rearward from the support portion.

In Embodiment 1 above, the press-to-unlock portion is formed at the rear end portion of the locking arm. However, in another embodiment, the press-to-unlock portion may be formed in the middle in the front-rear direction (in an intermediate portion with respect to the front-rear direction) of the locking arm.

### List of Reference Numerals

10: Connector
20: Housing
21: Cavity
22: Lance
24: Retainer attachment hole
25: Upper surface (one surface of housing)
26: Locking arm
27: Support portion
28: Extension portion
29: Leg portion
31: Press-to-unlock portion
32: Pressing surface
33: Arm portion
34: Locking main body portion
35: Side wall portion (first side wall portion)
36: Side wall portion (second side wall portion)
37: End wall portion
38: Wall portion
39: Unlocking space
41: Through hole
42: Beam portion
43: Finger placement face
50: Retainer
60: Terminal fitting
61: Main body portion
62: Barrel portion
70: Counterpart connector
71: Counterpart housing
72: Hood portion
73: Locking portion
74: Guide portion
75: Upper wall (upper wall of hood portion)
76: Recessed portion
77: Interior edge portion
78: Inclined edge portion
90: Counterpart terminal fitting
100: Electric wire

1. A connector comprising a housing to which a counterpart connector can be fitted from a front side,
wherein the housing includes a locking arm to which the counterpart connector is locked,
the locking arm extends in a front-rear direction above one surface of the housing, is elastically deformable in a direction in which the locking arm approaches the one surface of the housing, and includes a press-to-unlock portion capable of being pressed toward the one surface of the housing, and
the housing includes a wall portion that protrudes from the one surface and faces the press-to-unlock portion from a rear side.

2. The connector according to claim 1,
wherein a protrusion size of the wall portion from the one surface is larger than a distance from the one surface to a pressing surface of the press-to-unlock portion.

3. The connector according to claim 1,
wherein a width in a left-right direction of the wall portion is larger than a width in the left-right direction of the press-to-unlock portion.

4. The connector according to claim 1,
wherein the housing includes a finger placement face on the one surface on a rear side with respect to the wall portion.

5. The connector according to claim 1,
wherein the housing includes a pair of side wall portions that protrude from left and right sides of the locking arm on the one surface with the locking arm being located between the side wall portions, and
at least one of the pair of side wall portions is coupled to the wall portion.

6. The connector according to claim 5,
wherein one end portion of left and right end portions of the wall portion is coupled to the one of the side wall portions, and the other end portion is separate from the other of the side wall portions and forms an unlocking space together with the other side wall portion.
